(19) United States
(12) Patent Application Publication
(10) Pub. No.: US 2025/0227176 A1
(43) Pub. Date: Jul. 10, 2025

(54) DATA TRANSMISSION METHOD, APPARATUS, DEVICE, AND STORAGE MEDIUM

(71) Applicant: GUANGDONG OPPO MOBILE TELECOMMUNICATIONS CORP., LTD., Dongguan, Guangdong (CN)

(72) Inventor: Hua GUO, Dongguan, Guangdong (CN)

(73) Assignee: GUANGDONG OPPO MOBILE TELECOMMUNICATIONS CORP., LTD., Dongguan, Guangdong (CN)

(21) Appl. No.: 18/869,835

(22) PCT Filed: Mar. 21, 2022
(86) PCT No.: PCT/CN2022/082048

§ 371 Date: Nov. 26, 2024

(30) Foreign Application Priority Data
Apr. 14, 2021 (CN) 202110401925.7

(51) Int. Cl. H04M 1/72436; G06F 1/16; H04M 1/72409; H04W 52/02

(52) U.S. Cl. CPC H04M 1/72436; G06F 1/163; H04M 1/724095; H04W 52/0274

(57) ABSTRACT

A data transmission method, apparatus, and device, and a storage medium, which belong to the field of wearable devices. The method comprises: receiving first communication data sent by a terminal, the first communication data being transmitted by means of a data communication connection established between a first system and the terminal (301); processing the first communication data by using target middleware, and obtaining service data comprised in the first communication data, the target middleware being first middleware in the first system or second middleware in a second system (302); and by using the target middleware, sending the service data to a target application so that the target application can process the service data, the target application being an application in the first system or the second system (303).

The present application claims the priority of the Chinese patent application No. 202110401925.7, filed on Apr. 14, 2021, in the title of “DATA TRANSMISSION METHOD, APPARATUS, DEVICE, AND STORAGE MEDIUM”, contents of which are incorporated herein by its entireties.

### TECHNICAL FIELD

Embodiments of the present disclosure relate to the technical field of wearable devices, and more specifically, to a data transmission method, an apparatus, a device, and a storage medium.

### BACKGROUND

A wearable device is a portable electronic device that can be directly worn to or integrated into clothes or accessories, and common wearable devices include a smart watch, a smart bracelet, smart glasses, and so on.

In the related art, the wearable device establishes communication connection (such as Bluetooth connection) with a terminal, so as to transmit data with the terminal through the Bluetooth connection, such that interaction between the wearable device and the terminal is achieved. For example, the terminal may send a notification message to the wearable device via the Bluetooth connection, and the wearable device may perform notification and reminding.

### SUMMARY

The present disclosure provides a data transmission method, an apparatus, a device, and a storage medium.

In an aspect, the present disclosure provides a data transmission method, performed by a wearable device. The wearable device comprises a first system and a second system, the first system is run by a first processor, the second system is run by a second processor.

The method includes:
receiving first communication data sent by a terminal, wherein the first communication data are transmitted through data communication connection established between the first system and the terminal;
processing the first communication data through a target middleware to obtain business data contained in the first communication data; wherein the target middleware is a first middleware in the first system or a second middleware in the second system; and
sending the business data to a target application via the target middleware; processing, by the target application, the business data, wherein the target application is an application in the first system or an application in the second system.

In another aspect, the present disclosure provides a data transmission apparatus, arranged in a wearable device. The wearable device comprises a first system and a second system, the first system is run by a first processor, the second system is run by a second processor.

The apparatus includes:
a communication data receiving module, configured to receive first communication data sent by a terminal, wherein the first communication data are transmitted through data communication connection established between the first system and the terminal;
a communication data processing module, configured to process the first communication data through a target middleware to obtain business data contained in the first communication data; wherein the target middleware is a first middleware in the first system or a second middleware in the second system;
a business data sending module, configured to send, via the target middleware, the business data to a target application to be processed by the target application, wherein the target application is an application in the first system or an application in the second system.

In another aspect, the present disclosure provides a wearable device, including a processor and a memory. The processor includes at least a first processor and a second processor, the memory stores at least one instruction, the at least one instruction is configured to be executed by the processor to implement the data transmission method in the above aspect.

In another aspect, the present disclosure provides a computer-readable storage medium, storing at least one instruction. The at least one instruction is configured to be executed by a processor to implement the data transmission method in the above aspect.

In another aspect, the present disclosure provides a computer program product, comprising computer instructions, wherein the computer instructions are stored in a computer-readable storage medium; a processor of a computer device is configured to read the computer instructions from the computer-readable storage medium, the processor is configured to execute the computer instructions to cause the computer device to perform the data transmission method in the above aspect.

### BRIEF DESCRIPTION OF THE DRAWINGS

FIG. 1 is a schematic diagram of a framework of a second processor corresponding to dual-core communication software according to an embodiment of the present disclosure.

FIG. 2 is a schematic diagram of a framework of a first processor corresponding to dual-core communication software according to an embodiment of the present disclosure.

FIG. 3 is a flow chart of a data transmission method according to an embodiment of the present disclosure.

FIG. 4 is a schematic view of an interface during performing the data transmission method according to an embodiment of the present disclosure.

FIG. 5 is a flow chart of a data transmission method according to another embodiment of the present disclosure.

FIG. 6 is a schematic view of a timing sequence during performing the data transmission method shown in FIG. 5.

FIG. 7 is a flow chart of a data transmission method according to still another embodiment of the present disclosure.

FIG. 8 is a schematic view of a timing sequence during performing the data transmission method shown in FIG. 7.

FIG. 9 is a flow chart of a data transmission method according to still another embodiment of the present disclosure.

FIG. 10 is a schematic view of a timing sequence during performing the data transmission method shown in FIG. 9.

FIG. 11 is a schematic diagram of a framework of a software to dual-core communication software according to an embodiment of the present disclosure.

FIG. 12 is a schematic diagram of a data transmission apparatus according to another embodiment of the present disclosure.

FIG. 13 is a schematic diagram of a wearable device according to an embodiment of the present disclosure.

### DETAILED DESCRIPTIONS

In order to make the purposes, technical solutions and advantages of the present disclosure clearer, embodiments of the present disclosure will be described in further detail by referring to the accompanying drawings.

A term “a plurality of” in the present disclosure refers to two or more than two. A term “and/or” describes an association relationship of associated objects and indicates that three types of relationships may exist. For example, A and/or B may indicate that A is present alone, both A and B are present, and B is present alone. The character “/” generally indicates an object before the character “or” an object after the character.

In the related art, the wearable device is arranged with a single processor. The single processor runs an operating system to process all system events generated during the wearable device being operating. In addition, in order to achieve data linkage between the wearable device and a terminal, a communication module (such as a Bluetooth module) of the wearable device needs to be loaded on the processor, such that data received by the communication module is sent in real time to the operating system to be processed and responded by the operating system. Further, the wearable device may feedback a data processing result to the terminal through the communication module, such that mutual linkage between the terminal and the wearable device is achieved. Therefore, in order to ensure business data to be normally transmitted and timely responded, the processor needs to have a powerful data processing capability and needs to be maintained at an operating state at the time when the wearable device is operating.

However, for daily use, the wearable device in most cases only needs to achieve some functions that require low processing performance, or to achieve some simple linkage with the terminal. For example, a smartwatch or a smart bracelet, in most cases, only needs to display time or to display a notification message sent by the terminal. Therefore, enabling the processor to maintain at the operating state for a long period of time does not improve performance of the wearable device, but rather increases power consumption of the wearable device, and an endurance time of the wearable device may be decreased.

In embodiments of the present disclosure, the wearable device is configured with at least a first processor and a second processor having different processing performance and different power consumption. The first processor is configured to run a first system, and the second processor is configured to run a second system (i.e., dual cores and dual systems). In addition, the communication module of the wearable device is loaded on the first processor.

When the wearable device is operating, the first system on the processor having lower power consumption is run, events requiring low processing performance are processed, and the other processor having higher power consumption is kept in a dormant state (accordingly, the second system run by the other processor having higher power consumption is in the dormant state). In this way, while basic functions of the wearable device are achieved, power consumption of the wearable device is reduced.

Furthermore, since the first system is in the operating state, the wearable device can receive communication data sent by the terminal in real time through data communication connection established between the first system and the terminal can parse, through a middleware configured in the first system or the second system, the communication data to obtain the business data contained therein. Furthermore, applications in the system process the business data, ensuring the business data to be processed in time and achieving the linkage between the terminal and the When an event that requires high processing performance (such as when launching an application) occurs, the other processor having higher power consumption is awakened, and the second system is switched on to process the event to ensure that any triggered event can be responded to and processed in time, and performance requirements of the wearable device are satisfied.

In embodiments of the present disclosure, the first processor and the second processor operate asynchronously, and the first system and the second system need to perform system communication (also known as dual-core communication). In an application scenario, the first system is a Real Time Operating System (RTOS) running on a Micro Controller Unit (MCU), and the second system is the Android operating system running on a Central Processing Unit (CPU).

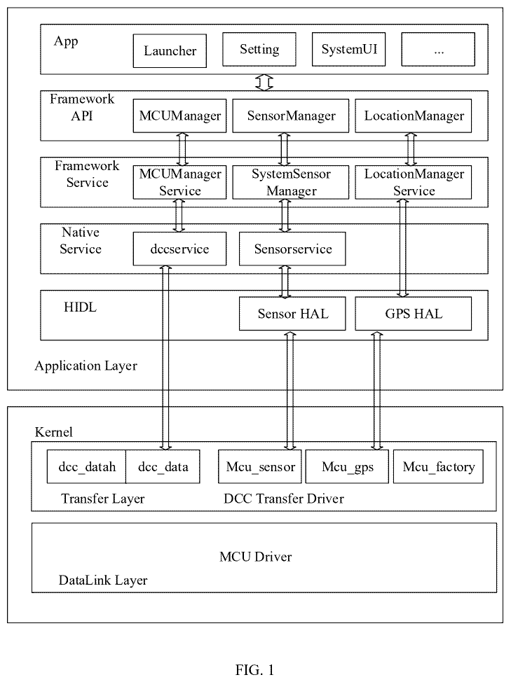

As shown in FIG. 1, a dual-core communication software framework for the Android operating system according to an embodiment of the present disclosure is shown. The dual-core communication software framework includes a kernel module, a hardware abstraction layer interface description language (HIDL) module, a native service module, a framework service module, a framework API module, and an application (APP) module.

The APP module includes functional modules, such as a launcher (desktop launcher) module, a setting and system user interface (system UI) module, and so on. The framework API module includes management modules, such as a MCU Manager module, a SensorManager module, a LocationManager module, and so on. The framework service module includes service modules, such as a MCUManagerService module, a SystemSensorManager module, a LocationManagerService module, and so on. The Native Service module includes service modules, such as a dccservice (dcc service) module, a Sensorservice module, and so on. The HIDL module includes modules, such as a Sensor HAL module, a GPS HAL module, and so on. The Kernel module includes dcc_datah, dcc_data, Mcu_sensor, Mcu_gps, Mcu_factory and other DCC Transfer Driver.

A transfer layer, serving as an interface layer connecting an upper layer and a lower layer in the dual-core communication software framework, shields transmission details of communication of the lower layer of the system (a data link layer) from an application layer, such that a service channel is provided for application scenarios. The application layer, serving as a subject of providing services, responds to human-computer interaction; transfers, through the transfer layer, data generated during the human-computer interaction; and responds to external data requests.

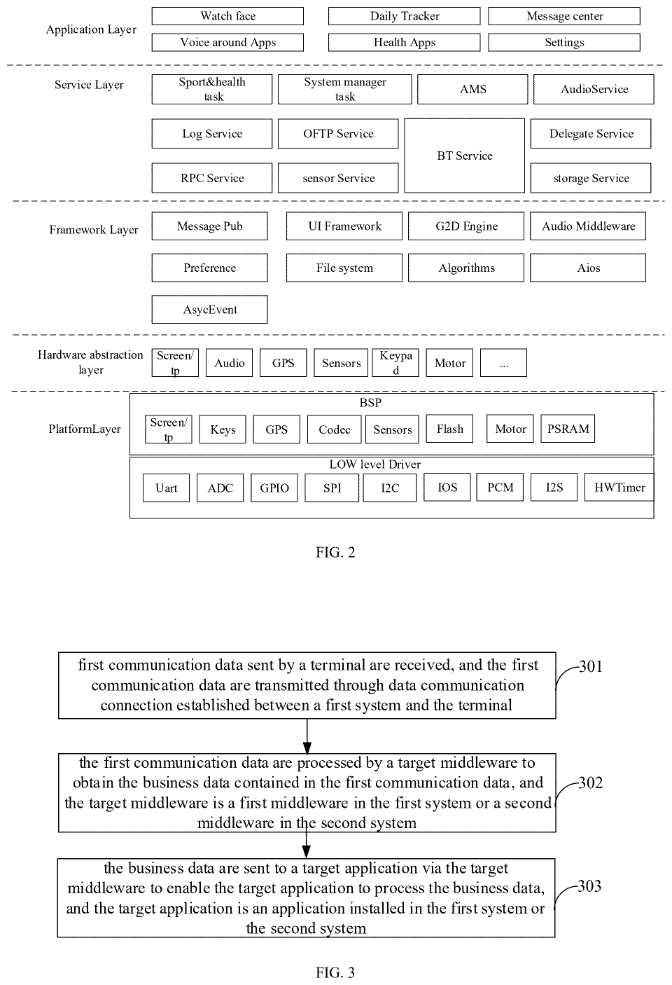

Taking the smartwatch as an example of the wearable device, FIG. 2 shows a dual-core communication software framework of RTOS according to an embodiment of the present disclosure.

The dual-core communication software framework of the RTOS includes an application layer, a service layer, a framework layer, a hardware abstraction layer and a platform layer.

The application layer includes a watch face module, a daily tracker module, a message center module, voice around applications module, health applications module, settings module and other application modules. The service layer includes service modules, such as a sport & health task module, a system manager task module, an activity management service (AMS) module, an AudioService module, a log service module, an OFTP service module, a Bluetooth (BT) Service module, a delegate service module, a remote provoking call (RPC) service module, a sensor service module, a storage service module, and so on. The framework layer includes framework modules, such as a Message Pub module, a user interface framework (UI framework) module, a G2D engine module, an Audio Middleware module, a Preference module, a File system module, an Algorithms module, an Aios module, an in-process asynchronous event (AsycEvent) module, and so on. The hardware abstraction layer includes hardware abstraction modules, such as a Screen/TP module, an Audio module, a GPS module, a sensors module, a Keypad module, a Motor module, and so on. The platform layer includes a board support package (BSP) and a LOW level Driver. The BSP includes Screen/TP, Keys, a GPS, a Codec, sensors, a Flash, a Motor, a PSRAM and so on. The LOW level Driver includes a Uart, an Analog to Digital Converter (ADC), general-purpose input/output (GPIO), a Serial Peripheral Interface (SPI), an Integrated Circuit Bus (I2C), an Input/Output System (IOS), Pulse Coded Modulation (PCM), an Integrated Audio Bus (I2S), a Hardware Timer (HWTimer).

It should be noted that the above dual-core communication software framework is for schematic illustration only. Any ordinary skilled person in the art may also perform addition, deletion or modification on the above framework according to the actual demands, and the present disclosure does not limit a specific structure of the dual-core communication software framework.

As shown in FIG. 3, FIG. 3 is a flow chart of a data transmission method according to an embodiment of the present disclosure. The present embodiment is illustrated by taking the wearable device as an example, and the method may include following operations.

In an operation 301, first communication data sent by a terminal are received, and the first communication data are transmitted through data communication connection established between a first system and the terminal.

In an embodiment, the wearable device is configured with a first processor and a second processor, the first processor is configured to run the first system, and the second processor is configured to run a second system. In some embodiments, processing performance of the first processor is lower than processing performance of the second processor (a processing capability and a processing speed of the first processor are lower than those of the second processor), and power consumption of the first processor is lower than power consumption of the second processor. Accordingly, the second system (operated by the second processor) can process events processed by the first system (run by the first processor), whereas the first system is not necessarily capable of processing events processed by the second system.

In a case that the wearable device is the smartwatch, the first processor is an MCU, the second processor is a CPU. The first system is an RTOS, and the second system is the Android operating system. Accordingly, the events that can be processed by the first system include displaying a watch face, switching an interface of the watch face, displaying a notification message, and other scenarios that require low processing performance or less interaction. The events that can be processed by the second system include answering an incoming call, launching an application, editing the watch face, function setting, and other scenarios that require high processing performance or strong interactions.

Unlike smartphones, which are electronic devices having strong interaction properties, the wearable device is an auxiliary electronic device and has weak interaction with a user in most cases. For example, in most scenarios, the user only lifts a wrist to check a time or a message prompt on the smartwatch. Therefore, during the wearable device operating, the first system maintains at an operating state, and the second system operates only in a scenario that requires high processing performance or strong interactions and remains in a dormant state in other scenarios.

Moreover, in order to ensure that the data sent by the terminal can be received and processed in time, in an embodiment, a communication module of the wearable device is loaded on the first processor. In this way, during the wearable device operating, the terminal and the first system can maintain the data communication connection, the wearable device maintains having low power consumption. To be noted that, when the second system is awakened and is in a foreground operating state (during which the first system is switched to a background operating state), the data communication connection between the first system and the terminal is still maintained. That is, during the wearable device operating, the wearable device transmits the communication data always through the data communication connection between the first system and the terminal.

In some embodiments, the data communication connection is Bluetooth connection, and the first processor communicates with a Bluetooth communication assembly via a physical serial port. The physical serial port may be a universal asynchronous receiver/transmitter (UART).

In some embodiments, when the terminal needs to send business data to the wearable device to be processed by the wearable device, i.e., the terminal packages the business data as the first communication data and sends the first communication data to the first system of the wearable device via the data communication connection. The first communication data may be obtained by an application program in the terminal (via a middleware SDK) invoking a middleware configured in the system to package the business data.

The middleware is a type of software configured between the operating system and the applications and is configured to connect the operating system layer to the application layer. By standardizing interfaces provided by the operating system and unifying protocols, standardized and unified public services are provided to upper-layer applications. In this way, a development workload of the upper-layer applications is reduced. The middleware in the present disclosure is configured to provide communication support for the first system and applications installed in the first system, or provide communication support for the second system and applications installed in the second system.

In an operation 302, the first communication data are processed by a target middleware to obtain the business data contained in the first communication data, and the target middleware is a first middleware in the first system or a second middleware in the second system.

In the present embodiment, each of the first system and the second system is configured with the middleware. The middleware is configured to: process the communication data to obtain the business data contained in the communication data; distribute the business data to the upper layer application to be processed; process data fed back by the upper layer application into communication data to be transmitted by the communication assembly.

In an embodiment, middlewares configured in various systems have different data processing capabilities. That is, the middleware in the system is configured to process the communication data containing particular business data, and business data that are processed by the middlewares in the various systems are preset.

In some embodiments, after receiving the first communication data through the first system, the wearable device determines the target middleware for processing the first communication data. In a case that the target middleware is the first middleware configured in the first system, the first communication data are processed by the first middleware. In a case that the target middleware is the second middleware configured in the second system, the first communication data are forwarded to the second system and processed by the second middleware. A specific manner of determining the target middleware will be described in detail in the following embodiments.

In an operation 303, the business data are sent to a target application via the target middleware to enable the target application to process the business data, and the target application is an application installed in the first system or the second system.

In an embodiment, the target middleware sends the business data to the target application in the system in which the target middleware is configured, or, the target middleware forwards the business data to the target application in the system other than the system in which the target middleware is configured. That is, the target application and the target middleware may be configured in one same system or in different systems.

In an embodiment, the target application is configured with the middleware SDK, and the middleware is invoked through the middleware SDK. In this way, data interaction with the middleware is achieved.

In an embodiment, after processing the business data, the system in which the target application is installed displays a processing result.

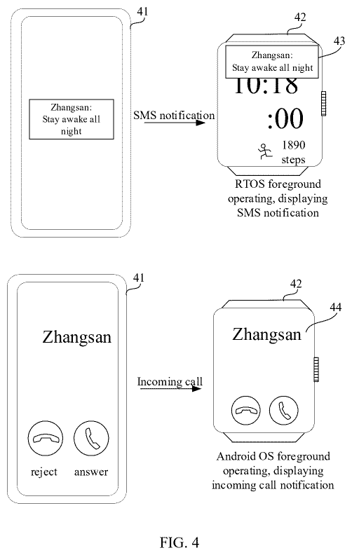

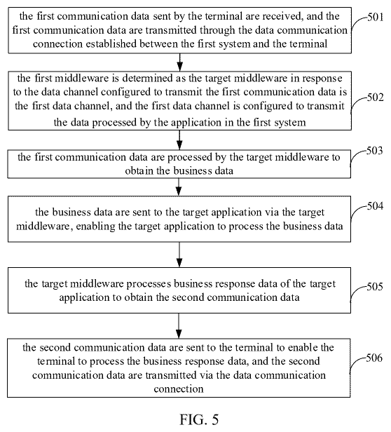

In an example, as shown in FIG. 4, the terminal 41 sends the communication data containing an SMS notification to the wearable device 42. In a case that the RTOS is in the foreground operating state, the wearable device 42 displays the SMS notification 43 at an upper layer of the interface of the watch face of the RTOS. The terminal 41 sends communication data containing an incoming call notification to the wearable device 42, and in a case that the Android operating system is in the foreground operating state, the wearable device 42 displays the incoming call notification 44 via a calling application of the Android operating system.

In summary, in the present embodiment, the wearable device is configured with the dual processors, the first processor runs the first system, and the second processor runs the second system. After the first system receives the communication data sent by the terminal through the data communication connection established between the first system and the terminal, the middleware configured in the first system or the second system processes the communication data to obtain the business data contained in the communication data. The middleware sends the business data to the application in the first system or the second system to perform business processing. Since the wearable device maintains data communication with the terminal through the first system, an effect caused by system switching on the data communication can be avoided, stability of the data communication between the wearable device and the terminal is ensured. In addition, the middleware configured in the system processes and distributes the data, ensuring that the business data can be processed in time and improving a business responding speed at the wearable device.

In addition, in a case that the power consumption of the first processor is lower than that of the second processor, since the data communication connection is established between the first system having the lower power consumption and the terminal, the power consumption of the wearable device can be reduced and normal transmission of the data is ensured.

In some embodiments, the operation of processing the first communication data by the target middleware to obtain the business data contained in the first communication data, includes following operations.

The target middleware is determined from the first middleware and the second middleware based on a data channel used for transmitting the first communication data. The data communication connection includes at least two data channels, and the at least two data channels are configured to transmit data having different processing requirements.

The target middleware processes the first communication data to obtain business data.

In some embodiments, the operation of determining the target middleware from the first middleware and the second middleware based on the data channel used for transmitting the first communication data, includes following operations.

The first middleware is determined as the target middleware in a case that the data channel used for transmitting the first communication data is a first data channel. The first data channel is configured to transmit data processed by the application in the first system.

The first middleware is determined as the target middleware in a case that the data channel used for transmitting the first communication data is a second data channel. The second data channel is configured to transmit the data processed by the application in the first system or the second system. The second middleware is determined as the target middleware in a case that the data channel used for transmitting the first communication data is a third data channel. The third data channel is configured to transmit the data processed by the application in the second system.

In some embodiments, the data channel configured to transmit the first communication data is the second data channel.

The operation of sending the business data to the target application via the target middleware, includes following operations.

The target application is determined based on a system operation state of the first system and a system operation state of the second system.

The business data are sent to the target application via the first middleware.

In some embodiments, the operation of determining the target application based on the system operation state of the first system and the system operation state of the second system, includes following operations.

A first application in the first system is determined as the target application in a case that the first system is in the foreground operating state.

A second application in the second system is determined as the target application in a case that the second system is in the foreground operating state.

In some embodiments, the second system is in the foreground operating state.

The operation of sending the business data to the target application via the first middleware, includes following operations.

The business data are sent to the first application via the first middleware.

The business data are sent to the second application via the first application to enable the second application to process the business data.

In some embodiments, the data channel configured to transmit the first communication data is the third data channel.

The operation of processing the first communication data by the target middleware to obtain the business data, includes following operations.

The first communication data are sent, through the first system, to the second middleware in the second system.

The second middleware processes the first communication data to obtain the business data.

In some embodiments, before sending the first communication data to the second middleware in the second system via the first system, the method further includes following operations.

In a case that the first system is in the foreground operating state, the second processor is switched from the dormant state to a wake-up state. When the second processor is in the wake-up state, the second processor is in the foreground operating state.

In some embodiments, after sending the business data to the target application via the target middleware, the method further includes following operations.

The target middleware processes business response data of the target application to obtain second communication data. The business response data are data generated by the target application performing business processing on the business data.

The second communication data are sent to the terminal to enable the terminal to process the business response data. The second communication data are transmitted via the data communication connection.

In some embodiments, the operation of sending the second communication data to the terminal includes following operations.

In a case that the target middleware is the second middleware, the second middleware sends the second communication data to the first system.

The first system sends the second communication data to the terminal.

In some embodiments, the data communication connection is Bluetooth connection, and the first processor communicates with the Bluetooth communication assembly via the physical serial port.

In some embodiments, the power consumption of the second processor is higher than the power consumption of the first processor.

In an embodiment, according to different data processing demands, the communication data sent from the terminal to the wearable device include following three types.

1. Data that are Unique for the First System and can be Processed by Only the First System

The business data contained in this type of communication data are data that require low processing performance or require weak interactions. For this type of communication data, it is only needed to display the processing result through the first system.

2. Data that are Unique for the Second System and can be Processed by Only the Second System

The business data contained in this type of communication data are data that require high processing performance or require strong interactions. For this type of communication data, specific applications in the second system are needed to provide business responses and display the processing result. For example, communication data containing the incoming call notification require the calling application in the second system to perform incoming call notification.

3. Data that are Common for Both the First System and the Second System and can be processed by either one of the first system and the second system

The business data contained in this type of communication data are data that require low processing performance or weak interactions and can may be processed by the first system or the second system depending on a foreground operation state of the system, and a processing result may be displayed. For example, for the communication data containing the SMS notification, an SMS notification banner is displayed by the system that is in the foreground operating state.

Of course, since functions to be achieved by the first system are usually a subset of functions to be achieved by the second system, in other embodiments, the communication data may include two types (i.e., the type 2 and the type 3 in the above), which are not limited by the present disclosure.

In order to enable the wearable device to recognize the communication data having different data processing requirements in order to enable the middleware in the corresponding system to process the communication data and to enable the target application in the system to perform business processing, the data communication connection established between the first system and the terminal includes at least two data channels, and data transmitted by the at least two data channels have different processing requirements.

In some embodiments, the number of the at least two data channels corresponds to the number of types of communication data. When the communication data include two types based on the data processing requirements, the data communication connection includes two data channels. When the communication data include three types based on the data processing requirements, the data communication connection includes three data channels. The present disclosure does not limit the number of data channels or the number of types of communication data.

Regarding to a manner of creating the at least two data channels, in an embodiment, when the Bluetooth connection is established between the wearable device and the terminal, the at least two data channels can be created in the Bluetooth connection using the Bluetooth Serial Port Profile (SPP) protocol. The present disclosure does not limit a specific manner of creating the at least two data channels.

Accordingly, after receiving the first communication data, the wearable device determines the target middleware from the first middleware and the second middleware based on the data channel configured to transmit the first communication data, so as to enable the target middleware to process the first communication data to obtain the business data. Correspondence between the data channels and the middlewares is configured in advance.

A process of processing the communication data for the above three processing requirements will be described below based on embodiments.

As shown in FIG. 5, FIG. 5 shows a flow chart of the data transmission method according to another embodiment of the present disclosure. The method of the present embodiment is illustrated by taking the wearable device as an example, and the method includes following operations.

In an operation 501, the first communication data sent by the terminal are received, and the first communication data are transmitted through the data communication connection established between the first system and the terminal.

Implementation of the operation 501 may be referred to as the operation 301 in the above, and will not be repeated herein.

In an operation 502, the first middleware is determined as the target middleware in a case that the data channel configured to transmit the first communication data is the first data channel, and the first data channel is configured to transmit the data processed by the application in the first system.

In an embodiment, before the terminal sends the communication data to the wearable device, the terminal firstly determines a data type of the communication data. In a case that the communication data are unique for the first system, the first communication data are sent to the first system via the first data channel.

Accordingly, when the first communication data are received through the first data channel, the first system determines that the business processing needs to be performed by the application in the first system, and therefore, the first middleware in the first system is determined as the target middleware.

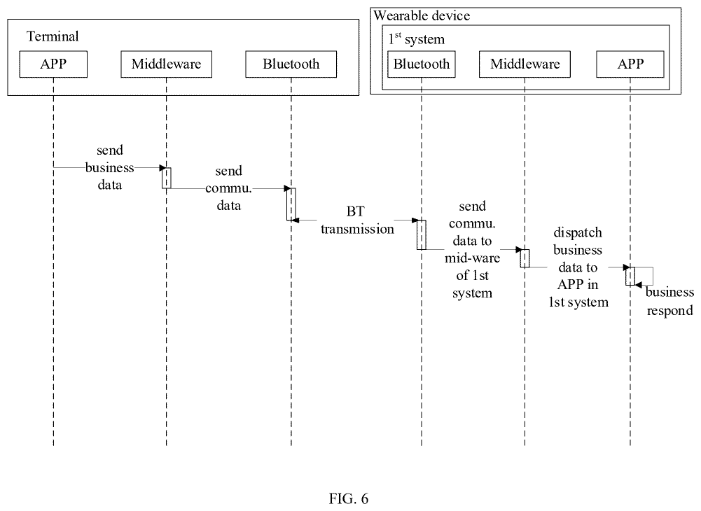

Exemplarily, as shown in FIG. 6, in an example, the Bluetooth communication is performed between the terminal and the wearable device. After an application in the terminal generates the business data, the terminal firstly sends the business data to the middleware. After the middleware processes the business data into the communication data, the middleware sends the communication data to the Bluetooth module, such that the communication data are transmitted to the Bluetooth module of the first system through the first data channel in the Bluetooth connection (as indicated by the middleware). After receiving the communication data through the first data channel in the Bluetooth connection, the first system determines that the business data in the communication data needs to be responded to by the first system, such that the middleware in the first system is determined as the target middleware.

In an operation 503, the first communication data are processed by the target middleware to obtain the business data.

Since the first middleware has the ability to process the business data that are unique for the first system, the first middleware can process the first communication data to obtain the business data contained in the first communication data. In some embodiments, the first middleware processes the first communication data to obtain the business data that can be recognized and processed by the upper layer application.

Exemplarily, as shown in FIG. 6, the communication data received via the Bluetooth connection are sent to the middleware of the first system, and the first system processes the communication data to obtain the business data.

In an operation 504, the business data are sent to the target application via the target middleware, enabling the target application to process the business data.

Since the data transmitted through the first data channel are unique for the first system, after the target middleware processes the data to obtain the business data, the target middleware further sends the business data to the target application in the first system to enable the target application to process the business data.

In some embodiments, during the target application processing the data, a processing result may be displayed, such that the user can be notified by the wearable device.

Exemplarily, as shown in FIG. 6, the middleware of the first system distributes the business data, obtained from processing the communication data, to the application in the first system, and the first system performs business responding.

In an operation 505, the target middleware processes business response data of the target application to obtain the second communication data.

In an embodiment, the target application processes the business data to generate the business response data. The business response data may be generated based on user interaction or automatically generated during the application processing the data. When the business response data needs to be fed back to the terminal, the target application processes the business response data through the target middleware to obtain the second communication data that satisfies transmission requirements of the communication connection. In the present embodiment, the target application processes the business response data through the first middleware to obtain the second communication data. A process of processing the business response data to obtain the second communication data can be interpreted as a reverse process of processing the first communication data to obtain the business data.

In some embodiments, the middleware SDK is configured in the target application. When the business response data needs to be transmitted to the terminal, the target application namely invokes the first middleware through the middleware SDK, and the first middleware processes the business response data.

In an operation 506, the second communication data are sent to the terminal to enable the terminal to process the business response data, and the second communication data are transmitted via the data communication connection.

The second communication data are sent through any one of the at least two data channels in the data communication connection or sent through the first data channel (i.e., transmitted through the same data channel as the first communication data).

In some embodiments, after the terminal receives the second communication data via the data communication connection, the terminal takes the middleware to process the second communication data to obtain the business response data and distributes the business response data to a corresponding application in the terminal.

In the present embodiment, the data unique for the first system are transmitted through the first data channel to enable the first system, after receiving the communication data, to process in time the data through the first middleware configured in the first system itself and to distribute the business data obtained after the processing to the application. In this way, timeliness and accuracy of the first system in processing the business data are improved.

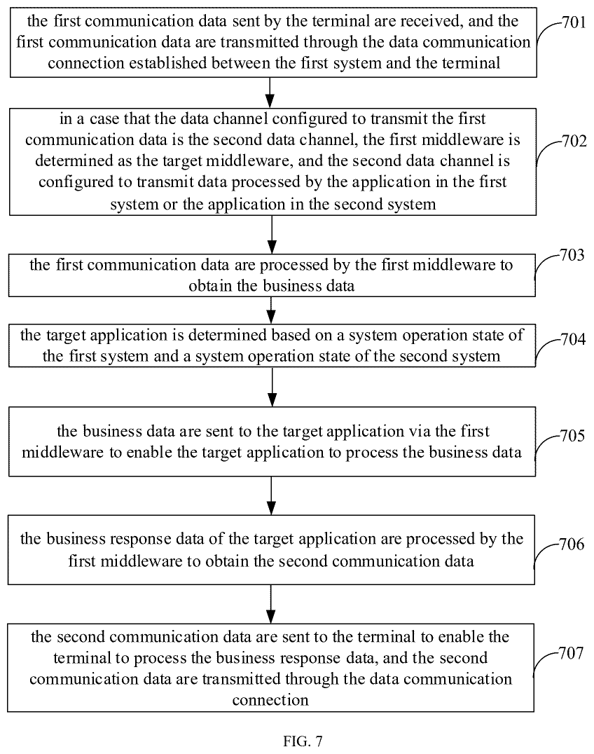

As shown in FIG. 7, FIG. 7 is a flow chart of the data transmission method according to still another embodiment of the present disclosure. The method of the present embodiment is illustrated by taking the wearable device as an example, and the method includes following operations.

In an operation 701, the first communication data sent by the terminal are received, and the first communication data are transmitted through the data communication connection established between the first system and the terminal.

Implementation of the present operation can be referred to in the operation 301 in the above and will not be repeated herein.

In an operation 702, in a case that the data channel configured to transmit the first communication data is the second data channel, the first middleware is determined as the target middleware, and the second data channel is configured to transmit data processed by the application in the first system or the application in the second system.

In an embodiment, before the terminal sends the communication data to the wearable device, the terminal firstly determines the data type of the communication data. In a case that the communication data are common to both the first system and the second system, the terminal sends the first communication data to the first system via the second data channel. Accordingly, when the first communication data are received via the second data channel, the first system determines that the business processing is to be performed by the application in the first system or the application in the second system.

In some embodiments, the first middleware further processes, in addition to the data that are unique for the first system, the data that are common to both the first system and the second system. Therefore, after receiving the first communication data via the second data channel, the wearable device determines the first middleware as the target middleware.

A reason for determining the first middleware, instead of the second middleware, as the target middleware is that the wearable device runs the first system for most of the time, and the second system is in the dormant state for most of the time. Therefore, determining the first middleware as the target middleware can improve the timeliness of processing the data and avoid an increase in power consumption caused by frequently waking up the second system (If the second middleware is determined as the target middleware, the second system needs to be woken up frequently to enable the second middleware to process the data).

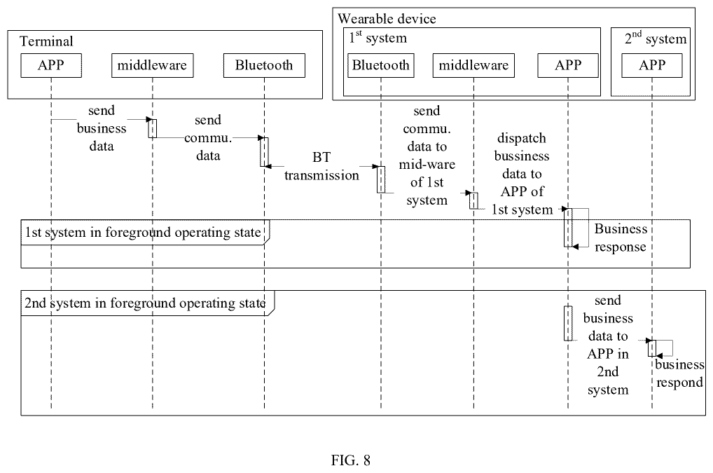

Exemplarily, as shown in FIG. 8, taking the Bluetooth communication between the terminal and the wearable device as an example, after the application in the terminal generates the business data, the terminal firstly sends the business data to the middleware. After the middleware processes the business data into the communication data, the middleware sends the communication data to the Bluetooth module, so as to transmit the communication data to the Bluetooth module of the first system via the second data channel in the Bluetooth connection (indicated by the middleware). After receiving the communication data via the second data channel in the Bluetooth connection, the first system determines that the communication data are common to both the first system and the second system, and either the first system or the second system needs to respond to the business data in the communication data, such that the first system determines the middleware in the first system as the target middleware.

In an operation 703, the first communication data are processed by the first middleware to obtain the business data.

Since the first middleware has the ability to process the data that are common to the first system and the second system, the first middleware can process the first communication data to obtain the business data contained in the first communication data. in some embodiments, the first middleware processes the first communication data to obtain the business data that can be recognized and processed by the upper layer application.

Exemplarily, as shown in FIG. 8, the communication data received via the Bluetooth connection are sent to the middleware of the first system, and the first system processes the communication data to obtain the business data.

In an operation 704, the target application is determined based on a system operation state of the first system and a system operation state of the second system.

Since only one system has a control authority for a graphical user interface of the wearable device at a same time point (i.e., a display screen of the wearable device can only be used by one system at one time point), for the data common to the first system and the second system, the wearable device determines the target application for processing the business data based on the system operation states of the dual systems, such that the target application can process and respond to the business data subsequently.

In some embodiments, the system operation state includes the foreground operating state, the background operating state, and the dormant state. The system operation state of the first system includes the foreground operating state and the background operating state (the dormant state is not set for the first system since the first system needs to maintain the communication data connection with the terminal). The system operation state of the second system includes the foreground operating state, the background operating state, and the dormant state (the dormant state is set for the second system to reduce power consumption of the terminal).

In an embodiment, in a case that the first system is in the foreground operating state, the wearable device determines that the target application is the first application in the first system. In a case that the second system is in the foreground operating state, the wearable device determines that the target application is the second application in the second system.

In an example, when receiving the SMS notification sent from the terminal, in a case that the first system is in the foreground operating state and the second system is in the dormant state, the wearable device determines a notification application in the first system as the target application; and in a case that the second system is in the foreground operating state and the first system is in the background operating state, the wearable device determines a notification application in the second system as the target application.

In an operation 705, the business data are sent to the target application via the first middleware to enable the target application to process the business data.

In an embodiment, the wearable device sends the business data, via the first middleware, to the target application in the system that is in the foreground operating state to enable the target application to process the business data. The first middleware sends the business data in different ways for different target applications in different systems.

In some embodiments, in the case that the target application is the first application in the first system, since both the first application and the first middleware are both installed in the first system, the first middleware can directly send the business data to the first application to enable the first application to process the business data.

In the case that the target application is the second application in the second system, since the second application and the first middleware are installed in different systems, the first middleware cannot directly send the business data to the second application. In an embodiment, the first middleware can indirectly send, through the first application, the business data to the second application.

In some embodiments, the wearable device sends the business data to the first application via the first middleware (the first application does not need to process the business data), such that the business data are sent to the second application via the first application, enabling the second application to process the business data. The first application may send the business data to the second application through the physical serial port between the first system and the second system. For example, the physical serial port may be a Serial Peripheral Interface (SPI).

Exemplarily, as shown in FIG. 8, in the case that the first system is in the foreground operating state, the middleware in the first system distributes the business data to the application in the first system, and the application in the first system performs the business responding; and in the case that the second system is in the foreground operating state, the middleware in the first system firstly distributes the business data to the application in the first system, and the application in the first system transfers the business data to the application in the second system, and the application in the second system performs the business responding.

In an embodiment, in the case that the first system is in the foreground operating state, the application in the first system saves the business data sent by the first middleware for a predetermined time length (such as 1s). When the second system is switched to be in the foreground operating state within the predetermined time length, in order to avoid business omission due to fast switching between systems, the application in the first system sends the business data to the application in the second system, such that the application in the second system processes and displays the business data.

In an operation 706, the business response data of the target application are processed by the first middleware to obtain the second communication data.

The business response data are data generated after the target application processes the business data.

In an embodiment, the target application generates the business response data after processing the business data, and the business response data may be generated based on the user interaction or may be automatically generated during the application processing the data. When the business response data needs to be fed back to the terminal, the target application processes, by the target middleware, the business response data to obtain the second communication data that satisfies the transmission requirements of the communication connection. In the present embodiment, the target application processes, by the first middleware, the business response data to obtain the second communication data.

In some embodiments, when the target application and the first middleware are installed in the same system, the target application directly sends the business data to the first middleware. When the target application and the first middleware are installed in different systems, the target application indirectly sends the business data to the first middleware through the application in the first system.

In some embodiments, in the case that the target application is the first application in the first system, the first application sends the business response data to the first middleware, and the first middleware processes the business response data. In the case that the target application is the second application in the second system, the second application sends the business response data to the first application in the first system, the first system sends the business response data to the first middleware, such that the first middleware processes the business response data.

In an operation 707, the second communication data are sent to the terminal to enable the terminal to process the business response data, and the second communication data are transmitted through the data communication connection.

The second communication data are transmitted via any one of the at least two data channels in the data communication connection; or the second channel data are transmitted via the second data channel (i.e., transmitted using the same data channel as the first communication data).

In some embodiments, after the terminal receives the second communication data via the data communication connection, the second communication data are processed by the middleware to obtain the business response data, and the middleware distributes the business response data to the corresponding application in the terminal.

In the present embodiment, the data common to both the first system and the second system are transmitted through the second data channel. After the first system receives the communication data, the first system distributes the business data, which are obtained by being processed by the middleware in the first system, to the application in the foreground system according to a foreground operation situation of the first system and a foreground operation situation of the second system. Therefore, the application in the foreground system processes and responds to the business data. In this way, the data common to both the first system and the second system can be processed more timely and more accurately.

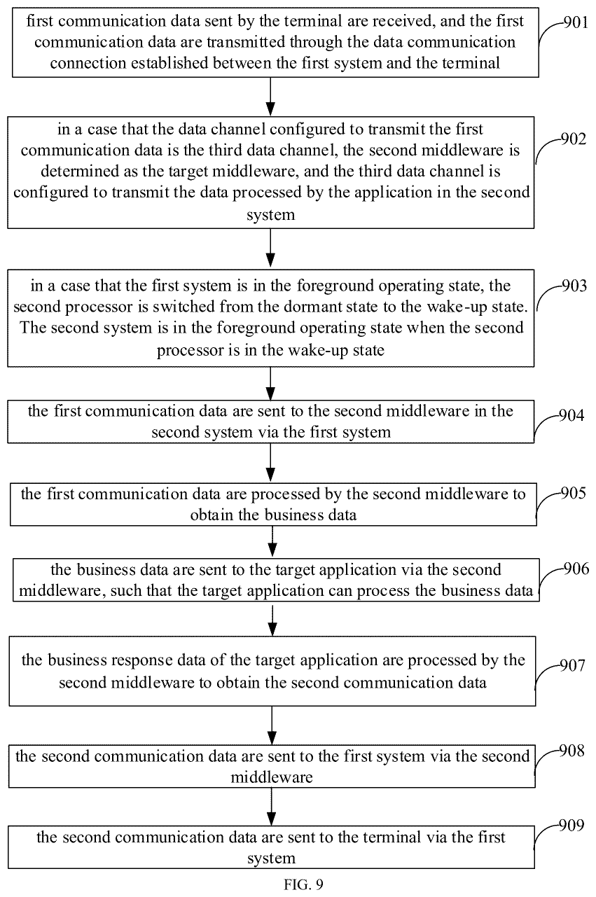

As shown in FIG. 9, FIG. 9 shows a flow chart of the data transmission method according to another embodiment of the present disclosure. The method of the present embodiment is illustrated by taking the wearable device as an example, and the method includes following operations.

In an operation 901, the first communication data sent by the terminal are received, and the first communication data are transmitted through the data communication connection established between the first system and the terminal.

Implementation of the present operation may be referred to as the operation 301 in the above, and will not be repeated herein.

In an operation 902, in a case that the data channel configured to transmit the first communication data is the third data channel, the second middleware is determined as the target middleware, and the third data channel is configured to transmit the data processed by the application in the second system.

In an embodiment, before the terminal sends the communication data to the wearable device, the terminal firstly determines the data type of the communication data. In a case that the communication data are unique to the second system (such as the incoming call notification), the first communication data are sent to the first system via the third data channel. Accordingly, when the first communication data are received via the third data channel, the first system determines that business processing needs to be performed by the application in the second system.

In the present embodiment, in order to ensure that the business data in the first communication data are correctly processed as business data recognizable by the application in the second system, the wearable device determines the second middleware as the target middleware, and the second middleware is specifically configured to the process the data that are unique for the second system.

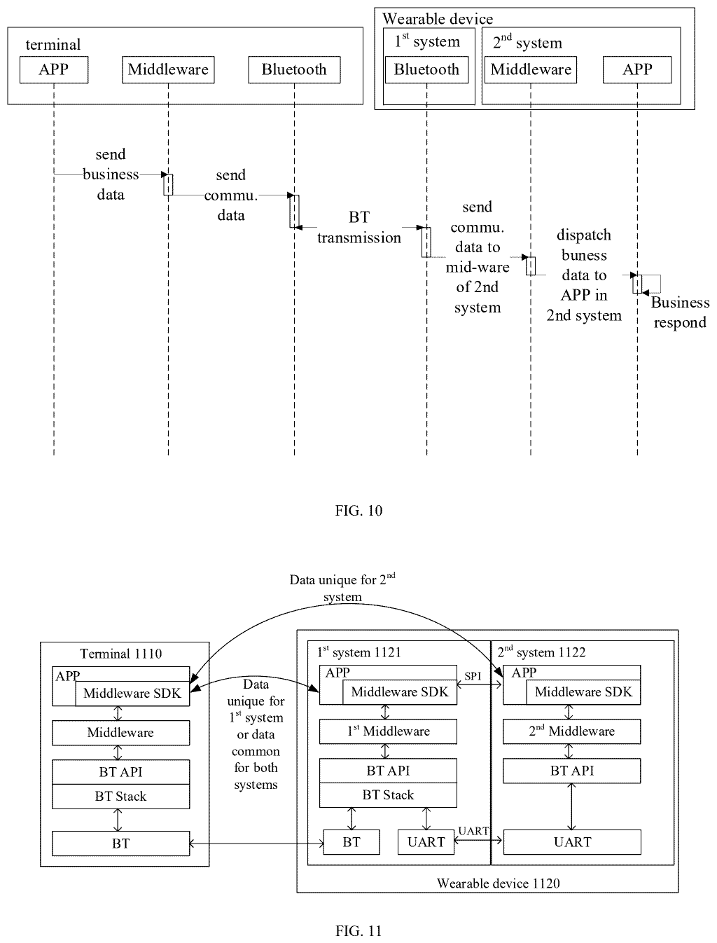

Exemplarily, as shown in FIG. 10, taking Bluetooth communication between the terminal and the wearable device as an example, after the application in the terminal generates the business data, the terminal firstly sends the business data to the middleware. After the middleware processes the business data into the communication data, the middleware sends the communication data to the Bluetooth module to transmit the communication data to the Bluetooth module of the first system through the third data channel in the Bluetooth connection (as indicated by the middleware). After receiving the communication data via the third data channel in the Bluetooth connection, the first system determines that the communication data are unique to the second system and the second system needs to respond to the business data in the communication data, such that the first system determines the middleware in the second system as the target middleware.

When the wearable device receives the first communication data, the first system is in the foreground operating state and the second system is in the dormant state. The second system in the dormant state cannot process the communication data by the second middleware. Therefore, the wearable device needs to detect whether the second system (i.e., the second processor) is in the foreground operating state. An operation 904 is performed in a case that the second system is in the foreground operating state, and an operation 903 is performed in a case that the second system is in the dormant state.

In the operation 903, in a case that the first system is in the foreground operating state, the second processor is switched from the dormant state to the wake-up state. The second system is in the foreground operating state when the second processor is in the wake-up state.

In an embodiment, in the case that the second processor is in the dormant state, the first processor wakes up the second processor by generating an interrupt. In the case that the second processor receives the interrupt, the second processor is switched from the dormant state to the wake-up state. Accordingly, after the second processor is woken, the second system is in the foreground operating state up, and the first system is switched to the background operating state.

In the operation 904, the first communication data are sent to the second middleware in the second system via the first system.

In an embodiment, when both the first system and the second system are in the operating state, the first system sends the first communication data through a physical serial port between the first system and the second system. The physical serial port may be a UART.

In some embodiments, the second system may not be configured with any communication protocol stack (since the communication assembly is loaded on the first processor), and therefore, before the first system sends the first communication data to the middleware of the second system, the first system needs to process the first communication data through the communication protocol stack configured in the first system to obtain the first communication data that can be recognized and processed by the middleware in the second system. For example, the first system firstly processes the first communication data through a Bluetooth protocol stack, and sends the processed first communication data to the second middleware in the second system.

Exemplarily, as shown in FIG. 10, in the case that the received communication data are unique to the second system, the first system sends the received communication data to the middleware of the second system.

In an operation 905, the first communication data are processed by the second middleware to obtain the business data.

Exemplarily, as shown in FIG. 10, after the middleware of the second system receives the first communication data, the middleware processes the first communication data into business data that can be recognized and processed by the application in the second system.

In an operation 906, the business data are sent to the target application via the second middleware, such that the target application can process the business data.

The target application is the second application in the second system, accordingly, the second middleware distributes the processed business data to the second application, and the second application performs business processing and responding.

Exemplarily, as shown in FIG. 10, the middleware in the second system distributes the business data to the application in the second system, and the application in the second system performs the business responding.

In an operation 907, the business response data of the target application are processed by the second middleware to obtain the second communication data.

The target application generates the business response data after processing the business data. The business response data are generated based on user interaction or automatically generated during the application processing the data. For example, when the business data is the incoming call notification, after the calling application displays the incoming call notification on the interface, the user can perform an answering operation or a rejection operation on the interface. The answering operation or the rejection operation generates the business response data correspondingly.

When the business response data needs to be fed back to the terminal (for example, an answering instruction or a rejection instruction needs to be fed back to the terminal), the target application processes the business response data through the target middleware to obtain the second communication data that meets the transmission requirements of the communication connection. In the present embodiment, the target application processes the business response data through the second middleware to obtain the second communication data.

In the present embodiment, since the second middleware and the target application are both installed in the second system, the target application may directly send the business response data to the second middleware.

In an operation 908, the second communication data are sent to the first system via the second middleware.

Since the wearable device establishes the data communication connection with the terminal through only the first system, and the second system does not establish the data communication connection with the terminal, the second system needs to take assistance from the first system to feedback the business response data to the terminal. In the present embodiment, the second middleware sends the second communication data, obtained after the processing, to the first system, and the first system feeds the second communication data back to the terminal via the data communication connection.

In an embodiment, the second system sends the second communication data through the physical serial port between the second system and the first system. The physical serial port may be the UART.

In an operation 909, the second communication data are sent to the terminal via the first system.

Further, the terminal sends the second communication data to the terminal via the first system. The second channel data are sent through any one of the at least two data channels in the data communication connection, or, the second channel data are sent through the third data channel (i.e., transmitted through the same data channel as the first communication data).

To be noted that since the second communication data received by the first system do not conform to a communication protocol, the first system needs to process (protocol packaging) the second communication data through a communication protocol stack before sending the second communication data to the terminal and sends the processed second communication data to the terminal. For example, the first system firstly processes the second communication data through the Bluetooth protocol stack, and then sends the processed second communication data to the terminal.

In the present embodiment, the data unique for the second system are sent through the third data channel, such that the first system, after receiving the communication data, forwards the communication data to the second system in time. The middleware in the second system processes the communication data. In this way, the application in the second system processes and responds to the business data obtained from the middleware in the second system processing the communication data. Timeliness and accuracy of processing the data unique for the second system are improved.

In combination with the above embodiments, in an example, when communication between the terminal and the wearable device is achieved via the Bluetooth (BT) connection, a software framework of the terminal and the wearable device is shown in FIG. 11.

An application is installed in the terminal 1110, and the application is configured with a middleware SDK. The application sends, through the middleware SDK, data to a BT API, such that the terminal sends the data to other devices via BT or the application obtains data received by the terminal via BT.

The wearable device 1120 is configured with the first system 1121 and the second system 1122. The first system 1121 communicates with the terminal 1110 via the Bluetooth connection (each of the terminal 1110 and the first system 1121 is configured with a respective BT stack, and the second system is not configured with the BT stack), and the first system 1121 and the second system 1122 communicate with each other via the physical serial port (the SPI and the UART).

When the terminal 1110 sends the data unique for the first system to the first system 1121 via the Bluetooth connection, the first system processes the data via the first middleware and distributes the business data, obtained after the processing, to the application in the first system, and the first system performs the business responding.

In the case that the terminal 1110 sends the data common to the first system and the second system to the first system 1121 via the Bluetooth connection, the first system processes the data via the first middleware and distributes the business data, obtained after the processing, to the application in the first system or the application the second system based on the foreground operation state of the first system 1121 and the foreground operation state of the second system 1122. In the case that the first system 1121 is in the foreground operating state, the first system 1121 distributes the business data to the application in the first system. In the case that the second system 1122 is in the foreground operating state, the application in the first system forwards the business data to the application in the second system via the SPI.

When the terminal 1110 sends the data unique for the second system to the first system 1121 via the Bluetooth connection, the first system 1121 forwards the data to the second system 1122 via the UART. The second middleware in the second system 1122 processes the data and distributes the business data, obtained after the processing, to the application in the second system, and the second system performs the business responding.

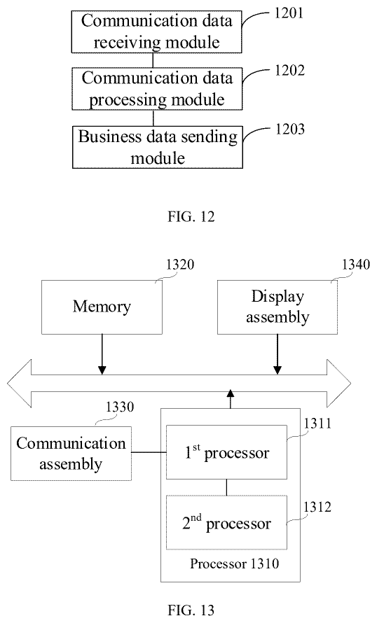

As shown in FIG. 12, FIG. 12 shows a block diagram of a data transmission apparatus according to an embodiment of the present disclosure. The apparatus may be achieved, through software, hardware, or a combination of both, as all or a part of the wearable device. The apparatus includes following components.

A communication data receiving module 1201 is configured to receive the first communication data sent by the terminal, and the first communication data are transmitted through the data communication connection established between the first system and the terminal.

A communication data processing module 1202 is configured to process the first communication data through the target middleware to obtain the business data contained in the first communication data. The target middleware is the first middleware in the first system or the second middleware in the second system.

A business data sending module 1203 is configured to send the business data to the target application via the target middleware, and the target application processes the business data, the target application is the application in the first system or the application in the second system.

In some embodiments, the communication data processing module 1202 includes following components.

A middleware determination unit is configured to determine the target middleware from the first middleware and the second middleware based on the data channel in which the first communication data are transmitted. The data communication connection includes at least two data channels, and the at least two data channels are configured to transmit data having different processing requirements.

A communication data processing unit is configured to process the first communication data through the target middleware to obtain the business data.

In some embodiments, the middleware determination unit is specifically configured to perform following operations.

The middleware determination unit is specifically configured to determine the first middleware as the target middleware in a case that the first communication data are sent through the first data channel. The first data channel is configured to transmit the data to be processed by the application in the first system.

The middleware determination unit is specifically configured to determine the first middleware as the target middleware in a case that the first communication data are sent through the second data channel. The second data channel is configured to transmit the data to be processed by the application in the first system or the application in the second system.

The middleware determination unit is specifically configured to determine the second middleware as the target middleware in a case that the first communication data are sent through the third data channel. The third data channel is configured to transmit the data to be processed by the application in the second system.

In some embodiments, the first communication data are sent through the second data channel.

The business data sending module 1203 includes following components.

An application determination unit is configured to determine the target application based on the system operation state of the first system and the system operation state of the second system.

A business data sending unit is configured to send the business data to the target application via the first middleware.

In some embodiments, the application determination unit is specifically configured to perform following operations.

The application determination unit is specifically configured to determine the first application in the first system as the target application in a case that the first system is in the foreground operating state.

The application determination unit is specifically configured to determine the second application in the second system as the target application in a case that the second system is in the foreground operating state.

In some embodiments, the second system is in the foreground operating state.

The business data sending unit is specifically configured to perform following operations.

The business data sending unit is specifically configured to send the business data to the first application via the first middleware.

The business data sending unit is specifically configured to send the business data to the second application via the first application, and the second application processes the business data.

In some embodiments, the first communication data are sent through the third data channel.

The communication data processing module 1202 includes following components.

A forwarding unit is configured to send the first communication data through the first system to the second middleware in the second system.

A communication data processing unit is configured to process the first communication data through the second middleware to obtain the business data.

In some embodiments, the apparatus further includes following components.

A waking up module is configured to switch the second processor from the dormant state to the wake-up state in a case that the first system is in the foreground operating state. The second system is in the foreground operating state when the second processor is in the wake-up state.

In some embodiments, the apparatus further includes following components.

A response data processing module is configured to process, through the target middleware, the business response data of the target application to obtain the second communication data. The business response data are data generated by the target application performing business processing on the business data.

A communication data sending module is configured to send the second communication data to the terminal, such that the terminal processes the business response data. The second communication data are sent through the data communication connection.

In some embodiments, the communication data sending module is configured to perform following operations.

The communication data sending module is configured to send the second communication data to the first system through the second middleware in a case that the target middleware is the second middleware.

The communication data sending module is configured to send the second communication data to the terminal via the first system.

In some embodiments, the data communication connection is the Bluetooth connection and the first processor communicates with the Bluetooth communication assembly via the physical serial port.

In some embodiments, the power consumption of the second processor is higher than the power consumption of the first processor.

In summary, in the present disclosure, the wearable device is configured with dual processors, and the first system is run by the first processor, and the second system is run by the second processor. When the first system receives the communication data sent by the terminal through the data communication connection established between the first system and the terminal, the communication data are processed by the middleware configured in the first system or the middleware configured in the second system to obtain the business data contained in the communication data. The middleware sends the business data to the application in the first system or the application in the second system for business processing. Since the wearable device maintains the data communication with the terminal through the first system, an influence caused by system switching on the data communication can be avoided to ensure stability of the data communication between the wearable device and the terminal. The middleware configured in the system performs the data processing and distributes the data, such that it is ensured that the business data can be processed in time, and the business responding speed on the wearable device is improved.

As shown in FIG. 13, FIG. 13 shows a block diagram of the wearable device according to an embodiment of the present disclosure. The wearable device of the present disclosure may include one or more of the following components: a processor 1310 and a memory 1320.

The processor 1310 includes at least the first processor 1311 and the second processor 1312. The first processor 1311 is configured to run the first system and the second processor 1312 is configured to run the second system. The power consumption of the first processor 1311 is lower than the power consumption of the second processor 1312. The performance of the first processor 1311 is lower than the performance of the second processor 1312. The processor 1310 is connected, via various interfaces and wires, to various portions in the entire electronic device to perform various functions of the electronic device and process data by running or executing instructions, programs, code sets, or instruction sets stored in the memory 1320 and by invoking data stored in the memory 1320. In some embodiments, the processor 1310 may be achieved by at least one hardware of: a digital signal processing (DSP), a field-programmable gate array (FPGA), and a programmable logic array (PLA). The processor 1310 may be one or a combination of: a central processing unit (CPU), a graphics processing unit (GPU), a neural-network processing unit (NPU), and a modem. The CPU substantially processes the operating system, user interfaces and application programs, and so on. The GPU is configured to render and draw contents to be displayed on a touch screen. The NPU is configured to achieve artificial intelligence (AI) functions. The modem is configured to perform wireless communication. Understandably, the modem may alternatively be implemented through a separated chip without being integrated into the processor 1310.

The memory 1320 may include a random access memory (RAM) or a read-only memory (ROM). In some embodiments, the memory 1320 includes a non-transitory computer-readable storage medium. The memory 1320 is configured to store instructions, programs, code, code sets, or instruction sets. The memory 1320 may include a storage program area and a storage data area. The storage program area may store instructions for implementing the operating system, instructions for at least one function (such as a touch function, a sound playing function, an image displaying function, and so on), instructions for implementing each of the method embodiments described in the above, and so on. The storage data area may store data created when the wearable device is being in use (such as audio data, contact list), and so on.

The wearable device in the present disclosure further includes a communication assembly 1330 and a display assembly 1340. The communication assembly 1330 may be a Bluetooth assembly, an Ultra Wide Band (UWB) assembly, and so on, and may be configured communicate with an external device via a wired or wireless network. The display assembly 1340 is configured to display a graphical user interface and/or to receive user interaction operations.

In the present disclosure, the first processor 1311 and the communication assembly 1330 are connected via the physical serial port. That is, when the first system is in the operating state, the first system may maintain Bluetooth connection with other devices to perform data communication via the Bluetooth connection.

In addition, it is understood by any ordinary skilled person in the art that the structure of the wearable device illustrated in the above-described accompanying drawings does not constitute a limitation of the wearable device, and the wearable device may include more or fewer components than illustrated or include a combination of certain components, or have a different arrangement of the components. For example, the wearable device further includes an RF circuit, an input unit, a sensor, an audio circuit, a speaker, a microphone, a power supply, and other components, which will not be described herein.

The present disclosure further provides a computer-readable storage medium storing at least one instruction. The at least one instruction is used to be executed by a processor to perform the data transmission method as described in the above embodiments.

The present disclosure further provides a computer program product, the computer program product includes computer instructions, the computer instructions are stored in the computer-readable storage medium. A processor of the computer device reads the computer instructions from the computer-readable storage medium, and the processor executes the computer instructions such that the computer device performs the data transmission method provided by the above embodiments.

It should be understood by any ordinary skilled person in the art that, in one or more of the above examples, the functions described in the embodiments of the present disclosure may be implemented using hardware, software, firmware, or any combination thereof. When implemented using software, the functions may be stored in a computer-readable medium or transmitted as one or more instructions or codes on a computer-readable medium. The computer-readable medium includes a computer storage medium and a communication medium. The communication medium includes any medium that facilitates transmission of a computer program from one location to another. The storage medium may be any available medium to which a general purpose or specialized computer has access.

The above description shows only embodiments of the present disclosure and is not intended to limit the present disclosure. Any modification, equivalent substitution, improvement, and so on, made within the spirit and principles of the present disclosure shall be included in the scope of the present disclosure.

1. A data transmission method, performed by a wearable device, wherein the wearable device comprises a first processor and a second processor, the first processor is configured to run a first system the second processor is configured to run the second system; and the method comprises:
receiving first communication data sent by a terminal, wherein the first communication data are transmitted through data communication connection established between the first system and the terminal;
processing the first communication data through a target middleware to obtain business data contained in the first communication data; wherein the target middleware is a first middleware in the first system or a second middleware in the second system; and
sending the business data to a target application via the target middleware; processing, by the target application, the business data, wherein the target application is an application in the first system or an application in the second system.

2. The data transmission method according to claim 1, wherein the processing the first communication data through a target middleware to obtain business data contained in the first communication data, comprises:
determining the target middleware from the first middleware and the second middleware based on a data channel in which the first communication data are transmitted, wherein the data communication connection comprises at least two data channels, and the at least two data channels are configured to transmit data having different processing requirements; and
processing the first communication data through the target middleware to obtain the business data.

3. The data transmission method according to claim 2, wherein the determining the target middleware from the first middleware and the second middleware based on a data channel in which the first communication data are transmitted, comprises:
determining the first middleware as the target middleware in a case that the first communication data are sent through a first data channel, wherein the first data channel is configured to transmit data to be processed by the application in the first system;
determining the first middleware as the target middleware in a case that the first communication data are sent through a second data channel, wherein the second data channel is configured to transmit data to be processed by the application in the first system or the application in the second system; and
determining the second middleware as the target middleware in a case that the first communication data are sent through a third data channel, wherein the third data channel is configured to transmit data to be processed by the application in the second system.

4. The data transmission method according to claim 3, wherein the first communication data are sent through the second data channel; and the sending the business data to a target application via the target middleware, comprises:
determining the target application based on a system operation state of the first system and a system operation state of the second system; and
sending the business data to the target application via the first middleware.

5. The data transmission method according to claim 4, wherein the determining the target application based on a system operation state of the first system and a system operation state of the second system, comprises:
determining a first application in the first system as the target application in a case that the first system is in a foreground operating state; and
determining a second application in the second system as the target application in a case that the second system is in the foreground operating state.

6. The data transmission method according to claim 5, wherein the second system is in the foreground operating state; and the sending the business data to the target application via the first middleware, comprises:
sending the business data to the first application via the first middleware;
sending the business data to the second application via the first application; and processing, by the second application, the business data.

7. The data transmission method according to claim 3, wherein the first communication data are sent through the third data channel; and the processing the first communication data through the target middleware to obtain the business data, comprises:
sending, through the first system, the first communication data to the second middleware in the second system; and
processing, through the second middleware, the first communication data to obtain the business data.

8. The data transmission method according to claim 7, wherein, before the sending, through the first system, the first communication data to the second middleware in the second system, the method further comprises:
switching the second processor from a dormant state to a wake-up state in a case that the first system is in a foreground operating state, wherein the second system is in the foreground operating state when the second processor is in the wake-up state.

9. The data transmission method according to claim 1, wherein, after the sending the business data to a target application via the target middleware, the method further comprises:
processing, through the target middleware, business response data of the target application to obtain second communication data, wherein the business response data are data generated by the target application performing business processing on the business data; and
sending the second communication data to the terminal; and processing, by the terminal, the business response data, wherein the second communication data are sent through the data communication connection.

10. The data transmission method according to claim 9, wherein the sending the second communication data to the terminal, comprises:
sending, through the second middleware, the second communication data to the first system in a case that the target middleware is the second middleware; and
sending the second communication data to the terminal via the first system.

11. The data transmission method according to claim 1, wherein, the data communication connection is Bluetooth connection, and the first processor communicates with a Bluetooth communication assembly via a physical serial port.

12. The data transmission method according to claim 1, wherein power consumption of the second processor is higher than power consumption of the first processor.

13-24. (canceled)

25. A wearable device, comprising a processor and a memory; wherein the processor comprises at least a first processor and a second processor, the memory stores at least one instruction, the at least one instruction is configured to be executed by the processor to implement a data transmission method;
wherein the wearable device comprises a first system and a second system, the first system is run by the first processor, the second system is run by the second processor; and the at least one instruction is configured to be executed to perform operations of:
receiving first communication data sent by a terminal, wherein the first communication data are transmitted through data communication connection established between the first system and the terminal;
processing the first communication data through a target middleware to obtain business data contained in the first communication data; wherein the target middleware is a first middleware in the first system or a second middleware in the second system; and
sending the business data to a target application via the target middleware; processing, by the target application, the business data, wherein the target application is an application in the first system or an application in the second system.

26. A non-transitory computer-readable storage medium, storing at least one instruction, wherein the at least one instruction is configured to be executed by a processor to implement operations of;
receiving first communication data sent by a terminal, wherein the first communication data are transmitted through data communication connection established between the first system and the terminal;
processing the first communication data through a target middleware to obtain business data contained in the first communication data; wherein the target middleware is a first middleware in the first system or a second middleware in the second system; and
sending the business data to a target application via the target middleware; processing, by the target application, the business data, wherein the target application is an application in the first system or an application in the second system.

27. (canceled)

28. The wearable device according to claim 25, wherein the processing the first communication data through a target middleware to obtain business data contained in the first communication data, comprises:
determining the target middleware from the first middleware and the second middleware based on a data channel in which the first communication data are transmitted, wherein the data communication connection comprises at least two data channels, and the at least two data channels are configured to transmit data having different processing requirements; and
processing the first communication data through the target middleware to obtain the business data.

29. The wearable device according to claim 28, wherein the determining the target middleware from the first middleware and the second middleware based on a data channel in which the first communication data are transmitted, comprises:
determining the first middleware as the target middleware in a case that the first communication data are sent through a first data channel, wherein the first data channel is configured to transmit data to be processed by the application in the first system;
determining the first middleware as the target middleware in a case that the first communication data are sent through a second data channel, wherein the second data channel is configured to transmit data to be processed by the application in the first system or the application in the second system; and
determining the second middleware as the target middleware in a case that the first communication data are sent through a third data channel, wherein the third data channel is configured to transmit data to be processed by the application in the second system.

30. The wearable device according to claim 29, wherein the first communication data are sent through the second data channel; and the sending the business data to a target application via the target middleware, comprises:
determining the target application based on a system operation state of the first system and a system operation state of the second system; and
sending the business data to the target application via the first middleware.

31. The wearable device according to claim 30, wherein the determining the target application based on a system operation state of the first system and a system operation state of the second system, comprises:
determining a first application in the first system as the target application in a case that the first system is in a foreground operating state; and
determining a second application in the second system as the target application in a case that the second system is in the foreground operating state.

32. The wearable device according to claim 31, wherein the second system is in the foreground operating state; and the sending the business data to the target application via the first middleware, comprises:
sending the business data to the first application via the first middleware;
sending the business data to the second application via the first application; and processing, by the second application, the business data.

33. The wearable device according to claim 29, wherein the first communication data are sent through the third data channel; and the processing the first communication data through the target middleware to obtain the business data, comprises:
sending, through the first system, the first communication data to the second middleware in the second system; and
processing, through the second middleware, the first communication data to obtain the business data.
